(19) United States
(12) Patent Application Publication
(10) Pub. No.: US 2010/0155325 A1
(43) Pub. Date: Jun. 24, 2010

(54) PARTICLE-TEMPLATED MEMBRANES, AND RELATED PROCESSES FOR THEIR PREPARATION

(75) Inventors: Lifeng Zhang, Clifton Park, NY (US); Hongyi Zhou, Niskayuna, NY (US); David Roger Moore, Albany, NY (US); Gary William Yeager, Rexford, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/343,522

(22) Filed: Dec. 24, 2008

(51) Int. Cl. B01D 39/14; C08J 9/26

(52) U.S. Cl. 210/500.21; 521/63

(57) ABSTRACT

A method for the formation of a membrane is described. A collection of substantially spherical particles formed from a selected material is contacted with at least one reactive material. The reactive material is cured or otherwise polymerized by various techniques, so that it forms a matrix that substantially surrounds and contains the particles. A portion of the particle material is then removed, so that the matrix contains a pattern of pores that are permeable to selected substances in solution. In some instances, the matrix is formed by an interfacial reaction between at least two reactive materials. Related filtration membranes are also described.

### BACKGROUND OF THE INVENTION

This invention relates generally to membranes. In some specific embodiments, the invention is directed to particle-templated membranes, which are useful for filtration processes. Methods for preparing such membranes constitute a variety of specific embodiments in this disclosure.

Membranes are critical elements for a wide variety of filtration processes, when controlling the passage of any selected substance through gas or liquid streams. As one example, membranes are the foundation of many processes directed to the viral clearance of biological products. The processes can be used to effectively remove viruses and other pathogens from solutions of medicinal products, or from raw materials used to make such products.

Typically, virus filtration membranes remove viruses based on size exclusion. For example, the larger virus particles can be “rejected” by the membrane, while smaller protein molecules are allowed to permeate through a membrane with high efficiency. Membranes that are used as virus filters are usually classified into two main categories: filters that are capable of removing viruses of 50 nm or larger (e.g., retroviruses); and filters that can remove smaller viruses (e.g., those in the 20 nm size), such as parvoviruses. Membranes can be formed from a wide selection of organic materials such as polymers; inorganic materials such as ceramics or metal oxides; and various combinations of such materials.

As one specific example, membrane filtration is important for the production of protein therapeutics from mammalian cells. In many cases, the inert nature of virus filtration is ideal; removing viruses without the potential of contaminating or damaging the protein product. The strategy for virus removal can also potentially mitigate the severity of additional inactivation strategies, such as irradiation, temperature or low pH treatment, ethanol treatment, or solvent/detergent treatment.

Membrane ultrafiltration, wherein the filter pore size is smaller than the smallest virus to be cleared, yet larger than the size of the protein to be isolated, is a common method for removing viruses from protein solutions. It provides a size-based exclusion of viral particles from protein product streams. However, contamination can occur when the virus is smaller in size than the membrane pore size, allowing viral contaminants to leak through the membrane. This is a persistent problem with parvovirus clearance—particularly using filtration membranes produced through a coagulation process. The use of virus-specific membranes having too small of a pore size can result in clogging and consequential reduction in flow rates and productivity.

Membranes have been prepared by many techniques over the years. One well-known technique is a phase-inversion process, in which an insoluble or immiscible species such as water is introduced into a thin liquid film of a polymer dissolved in an organic liquid. Polymer films precipitated from solutions in this way develop a network of pores, due to the presence of the immiscible phase during the precipitation process.

Other methods for the preparation of macroporous membranes are known in the art. Examples of such processes are provided in “Template-Directed Preparation of Macroporous Polymers With Oriented and Crystalline Arrays of Voids”, by P. Jiang et al; J. Am. Chem. Soc. 1999, 121, 11630-11637; and “Preparation of Three-Dimensionally Ordered Macroporous SiO₂ Membranes with Controllable Pore Size”, K. Zhao et al; Chemistry Letters, Vol. 36, No. 3 (2007), pp. 464-465. Another exemplary reference is entitled “Fabrication of Three-Dimensional Macroporous Membranes with Assemblies of Microspheres as Templates”, by S. Park et al; Chem. Mater., (1998), 10, 1745-1747.

For almost all end use applications, the quality of the membrane is largely dependent on a number of very important features, such as pore diameter, pore size distribution, and pore morphology. The synthetic approaches to forming these membranes have usually focused on creating internal voids with controllable, monodisperse diameters. One dominant approach is based on the use of patterning or “templating” techniques, which often involve the self-assembly of pore-forming spherical particles to form a sacrificial template on a substrate. These techniques can be successful in preparing satisfactory membranes on a laboratory scale, but the overall process can often be somewhat complex and time-consuming.

In an exemplary templating technique, one of the last key steps is the partial or complete removal of the templated spherical particles, to form the porous framework. The way in which the particle material is removed will depend in part on the composition of the particle. As described in the Zhao et al article mentioned above, a calcination process is sometimes used to decompose polymer spheres, that ultimately form the porous structure. Calcination is accompanied by a sintering technique, which solidifies and strengthens a silica network that provides a framework for the spheres. In other cases, acids like hydrofluoric (HF) acid are used to remove templates composed of the silica spheres, so as to form the porous membrane.

An overall review of the prior art suggests that some deficiencies remain in membrane quality, and in some of the assembly techniques for preparing various filtration membranes. As an example, the phase-inversion process discussed above can efficiently produce various membrane structures. However, it is in general very difficult to control pore size distribution in such membranes. Furthermore, some of the templating techniques described above require the use of relatively high calcination temperatures. They also require the use of strong acids like HF acid, which can necessitate the use of additional, burdensome safety and environmental procedures. Moreover, some of the prior art methods involve complex processing steps that may not be readily adaptable to larger-scale, commercial production systems.

It should thus be apparent that new processes for preparing membrane structures would be desirable in the art. The processes should be relatively simple in terms of method steps. For some end-uses, the process should also preferably avoid the large-scale use of strong acids or caustic materials, e.g., relying instead on systems which are generally aqueous-based, or which don't rely on strong acids/bases. Moreover, in some cases, the processes should avoid the excessive use of high-temperature steps, which can be energy-intensive, and which can sometimes adversely affect the membrane structure. Furthermore, the processes should be generally amenable to larger-scale commercial production. The resulting membrane structure should preferably be characterized by a desired pore size and pore distribution, e.g., a narrow pore size distribution capable of efficiently purifying therapeutic proteins from viral contaminants. The membrane should also be durable enough for efficient industrial use.

### BRIEF DESCRIPTION OF THE INVENTION

One embodiment of the present invention is directed to a method for the formation of a membrane, comprising the steps of:
a) contacting a collection of substantially spherical particles with at least one reactive material, wherein the particles are formed from a selected particle material;
b) reacting the reactive material, so that it forms a matrix which substantially surrounds and contains the particles; and
c) removing at least a portion of the particle material from the particles, so that the matrix comprises a pattern of pores that are permeable to selected substances in solution.

In another embodiment, the substantially spherical particles are in contact with a first reactive material that is disposed on the surface of a porous substrate. A second reactive material is placed into contact with at least a portion of the first reactive material and with the spherical particles, so that the two reactive materials react at an interface, to form a cured matrix material in which the particles are contained. Material in the particles can then be removed as discussed herein, to form the desired porous structure for a membrane.

In another embodiment, the outer surfaces of the spherical particles are provided with functional sites that can be reacted with an additional reactive material, to form the cured matrix material. The functional sites can be provided by different techniques, e.g., by treatment of the particles with a functionalizing composition, or by incorporating a functionalizing composition into the particles during their formation. The particle material is then removed to form the porous structure.

In still another embodiment, a filtration membrane is described. The membrane comprises a polymeric matrix that contains polyallylamine functionality or polyallylamine-derivative functionality. The matrix further comprises a bimodal distribution of primary pores and secondary pores, wherein the secondary pores are smaller in size than the primary pores; and are present at contact sites between the primary pores.

Other features and advantages will be apparent from a review of the following detailed description of the invention. Moreover, as used throughout this disclosure, the terms “a” and “an” do not denote a limitation of quantity, but rather denote the presence of at least one of the referenced items. The suffix “(s)” as used herein is intended to include both the singular and the plural of the term that it modifies, thereby including one or more of that term (e.g., “particles” can include one or more particles).

### BRIEF DESCRIPTION OF THE DRAWINGS

FIGS. 1A-1E depict general process steps in the formation of a membrane according to one embodiment of this invention.

FIGS. 2A-2D depict general process steps in the formation of a membrane according to another embodiment of this invention.

FIGS. 3A-3D depict general process steps in the formation of a membrane according to still another embodiment of this invention.

FIG. 4 is a microscopic surface image of a collection of templated polystyrene particles.

FIG. 5 is a microscopic surface image of a particle-templated membrane after templated particles have been removed.

FIG. 6 is a microscopic surface image of another particle-templated membrane after templated particles have been removed.

### DETAILED DESCRIPTION OF THE INVENTION

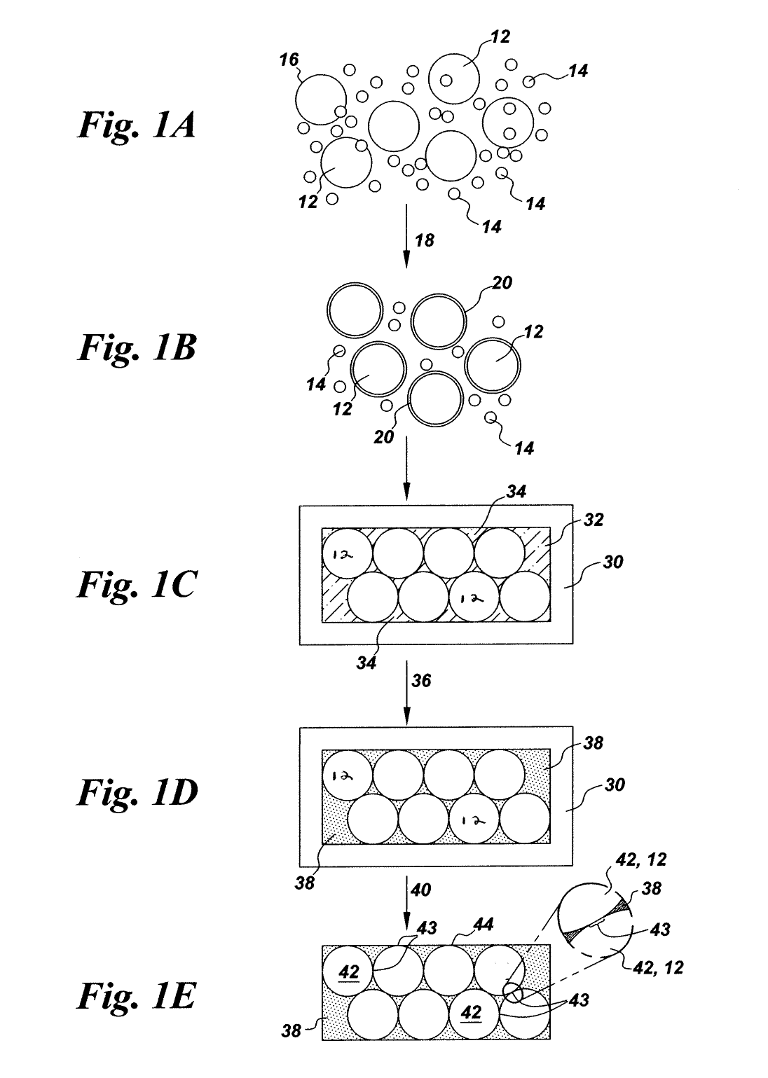

As alluded to previously, and with reference to a first embodiment depicted in FIG. 1, a collection of substantially spherical particles 12 is used as the pore-forming element for embodiments of this invention. (“Collection” simply describes a multitude of particles, i.e., the number used to eventually form a membrane of a desired dimension). While the particles formed from many processes are highly spherical in shape, “perfect” spheres are not necessary for this invention.

In some embodiments, the particles comprise an inorganic material, or combinations thereof. Non-limiting examples include ceramics such as titania, zirconia, alumina, silica, ruthenium oxide, and tin oxide. Metallic materials (or combinations thereof) can also be used. Non-limiting examples include titanium, zirconium, aluminum, chromium, iron, zinc, nickel, gold, silver, and platinum; as well as calcium or calcium precipitates (e.g., calcium carbonate). Cermets could also be used to form the particle material. Moreover, materials like silica may be employed in various forms. Non-limiting examples include colloidal silica, silica aerogels, and glass spheres.

In other embodiments, the particles 12 comprise an organic material, e.g., one formed from various polymers or copolymers. The particles can be formed from thermoplastic or thermosetting copolymers, although thermoplastic materials are often preferred, because of the relative ease in removing particle material afterward. A variety of polymers may be used. Non-limiting examples include polystyrene, polyamide, polyethylene, polypropylene, polycarbonate, polyester, polyacrylates and related polymers (e.g., polymethyl methacrylates); polyacetals, polybutenes, polyacryamides, polyalkylene glycols, polysiloxanes, polyphenylene sulfides, polylactides, and polysaccharides (e.g., cellulosic polymers). The polymers may be in the form of homopolymers or copolymers (e.g., branch- or graft-copolymers). Physical mixtures of such materials are also possible. In some specific embodiments, the polymer is in latex form, e.g., a stable dispersion of polymer microparticles. A variety of polymers can be used to form latex particles, e.g., vinyl acetate, styrene, styrene-butadiene, and (meth)acrylates. Techniques for preparing the latex particles are known in the art. It should also be noted that, in some embodiments, the particles could comprise combinations of organic and inorganic materials. Examples of such combinations include composite materials which comprise clay and at least one organic polymer.

With reference to FIG. 1, the choice of a particular particle 12 material—be it organic or inorganic—will depend on various factors. They include: the physical and chemical compatibility of the particle material with a reactive material which contacts the particle (as described below); the capability of the particles to form closely packed spheres when required; the capability of the particle material to be dissolved or otherwise removed after the formation of a surrounding matrix (as also described below); cost considerations; environmental considerations; and safety considerations. The particles may be in solid form; partially solid form, or hollow form, such as hollow spheres.

The size of the particles will be determined in part by the desired size for the membrane pores, which, in turn, is related to the membrane filtration application being pursued. In general, the particles usually have an average diameter in the range of about 50 nm to about 1000 nm, and for the purpose of this disclosure, such a range is considered to constitute “nanoparticles”. In some specific embodiments, the particles have an average diameter in the range of about 75 nm to about 250 nm.

As mentioned above, the particles are contacted with at least one reactive material 14 (FIG. 1A), which will be further described below. Although the reactive material 14 is illustrated in discrete, particle form in FIG. 1A, it should be understood that the material can be in the form of a continuous phase. For example, the reactive material can be in the form of a liquid, e.g. an emulsion in which individual reactive particles are dispersed. Moreover, the reactive material is often hydrophobic or partially hydrophobic, which enhances contact of the reactive particles with spherical particles 12.

In some embodiments, the reactive material should be one that will provide a substantially hydrophilic membrane, upon completion of the process. The hydrophilic membrane can sometimes impart biocompatibility. The biocompatibility characteristic may be useful in a number of situations, e.g., in preventing protein binding during use of the membrane in certain biological filtration processes. In other embodiments, a reactive material which will provide a substantially amphiphilic membrane is chosen. (For embodiments that use a second reactive material, as discussed below, the same considerations would be present for its selection).

Non-limiting examples of reactive material 14 include a compound or compounds comprising one or more groups selected from vinyl (e.g. acrylates, methacrylates, acrylamides, methacrylamides, epoxyacrylates, maleates, fumarates, styrenics (including 4-oxystyrene or 4-oxymethylenestyrene), maleimides, trifluorovinyloxy), compounds containing carbon-heteroatom multiple bonds (e.g. isocyanate, isothiocyanate, cyanate ester, carbonyl chlorides); compounds containing strained ring (e.g. epoxies, oxetanes, aziridines, cyclobutenes (including benzocyclobutenes), lactones, sultones), halides (sulfonyl chlorides, phosphoryl chlorides, halomethylketones, carbonyl chlorides), or esters (e.g., inorganic or organometalic esters such as trialkoxysilanes).

Preferred examples of reactive material 14, which will also provide the aforementioned substantially hydrophilic membrane, include diacrylates such as polyethylene glycol diacrylate, tetra(ethylene glycol) diacrylate, trimethylolpropane ethoxylate (1 EO/OH) methyl ether diacrylate; 1,3-butanediol diacrylate; glycerol 1,3-diglycerolate diacrylate; 1,6-hexanediol ethoxylate diacrylate (average Mn ˜314); bisphenol A ethoxylate diacrylate (average Mn ˜688, EO/phenol 4); tri(propylene glycol) glycerolate diacrylate; and poly(propylene glycol) diacrylate (average Mn ˜900 or 4000). Select triacrylates include trimethylolpropane ethoxylate triacrylate (average Mn ˜912), and trimethylolpropane propoxylate triacrylate. Dimethylacrylates include, but are not limited to, poly(ethylene glycol) dimethacrylate (varying molecular weights); poly(propylene glycol) dimethacrylate; and 1,3-butanediol dimethacrylate.

Compounds that can react with the aforementioned list are also examples of reactive material 14. Non-limiting examples include compounds that comprise reactive nitrogen groups (e.g. amine), oxygen groups (e.g. alcohol, phenol, anhydride), or sulfur (e.g. thiol, sulphinyl) groups. Catalysts or initiators for the cure of any of the aforementioned compounds are also included, such as amines (e.g. alkyl-, cycloalkyl- or heterocyclic amines), inorganic salts (for example, tin, zinc, manganese, iron); peroxides (including alkyl and acyl peroxides); or azo compounds. Other reactive materials and groups may be found in U.S. Patent Publication 20070039874 (Kniajanski et al), published on Feb. 22, 2007, which is incorporated herein by reference. As also mentioned above, the reactive material can be in the form of an emulsion. These materials could be used alone or in combination with each other, or with other compounds not specifically listed.

Contact between spherical particles 12 and reactive material 14 can be carried out in a number of different ways. For example, the reactive material, in liquid form (e.g., the emulsion) can be sprayed or poured over the spherical particles. Usually, the simplest method would be to combine the spherical particles with the reactive material in any suitable mixing vessel, forming a mixture of the constituents. In some cases, the mixture may further include at least one surfactant, which enhances physical contact between the reactive material and the outer layer 16 of the spherical particles. As designated by step 18, contact between particles 12 and material 14 often results in a relatively thin layer 20 of reactive material (e.g., monomer or oligomer), deposited on the outer layer 16 of the particles 12 (FIG. 1B). While layer 20 is depicted as continuous in the figure, the layer can in some instances be discontinuous.

The mixture of reactive material and spherical particles can be applied over a substrate 30, to form a film 32 on the substrate (FIG. 1C). Many different types of substrates are possible, as long as they maintain their integrity during subsequent processing steps, e.g., heating and washing steps which might involve contact with organic solvents, acids, and bases. Inorganic or organic materials may be used, including ceramic, metallic, or plastic materials. In some instances, plastic-type materials, which would allow for relatively easy removal or “lift-off” of a completed membrane after processing, are preferred. However, in some preferred embodiments when the substrate is porous, it can remain in place, and function as part of the overall membrane.

The reactive material/spherical particle mixture can be applied over the substrate by a number of techniques. Non-limiting examples include spraying techniques (e.g., spray coating); dip coating, spin coating, blade- or knife coating, bar coating, roll coating, vacuum filtration, painting, gravure coating, air brushing, or simply pouring the coating in measured amounts. The thickness of the film (e.g., film 32 in FIG. 1C) will depend on various factors, such as the desired thickness of the final membrane; the size and composition of the spherical particles; and the concentration of particles in the mixture. Usually, the thickness will be in the range of about 0.1 micron to about 100 microns; and in some specific embodiments, about 0.2 micron to about 50 microns. Within film 32, spherical particles 12 tend to form an ordered structure, with reactive material 14 substantially filling in the spaces or voids 34 between the particles.

As illustrated in step 36, reactive material 14 can then be reacted to form a cured or polymerized matrix surrounding spherical particles 12 (FIG. 1D). As used herein, a “reactive material” (most often a monomer or oligomer) is one that can be polymerized or otherwise cured, to form the cured/polymerized matrix (now depicted as element 38 for situational clarity), which substantially surrounds and contains the particles. The curing or polymerization can be effected by a number of techniques, including thermal-treatment; irradiation (e.g., ultraviolet (UV) curing); electron beam (EB); and combinations of such techniques. Catalysts are often used in the other curing processes.

As those skilled in the art understand, curing or polymerization reactions can involve a number of different mechanisms, such as addition (e.g., free radical addition), condensation, cross-linking, and the like. Certain mixtures of reactive materials may be cured at about room temperature (e.g. 25° C.), or slightly above (50° C.). Examples include compounds containing epoxy, urethane, vinyl (such as acrylate or methacrylate) and/or carbonyl chloride groups, with compounds containing amine or alcohol and/or catalysts or initiators. In the case of these various low-temperature curing polymers, such as some of the epoxies or acrylate materials, simple drying in an air atmosphere is sufficient to cure the reactive material 14 to form the matrix 38. The curing process may be accelerated by adding a catalyst, and/or increasing the temperature of the curing environment, e.g., up to about 65° C. Techniques for determining whether the matrix has adequately cured are well-known in the art. As an example, tack tests can be used; along with standard mechanical tests for density, tensile strength and modulus, flexural strength, and the like.

As further shown in FIG. 1E, at least a portion of the spherical particle material is removed in step 40. Removal of the particle material can be accomplished by a number of techniques. The particular technique chosen will depend in large part on the material which formed the particle. As one example, particles formed from inorganic materials such as silica or zirconia may be partially or substantially removed with selected strong bases such as sodium hydroxide or sodium hypochlorite, or with selected acids, such as hydrochloric acid, hydrofluoric acid, or sulfuric acid. (In the case of any solvent treatment or “solvent etching”, the solvent or solvent-combination should be one which removes a desired amount of the spherical particle material, but which does not remove or adversely affect the matrix that surrounds such particles).

In the case of polymer-based particles, removal of the polymeric material is usually carried out by either dissolution of the polymer; or degradation of the polymer (e.g., by way of hydrolysis). Examples of polymers ideally removed by dissolution include solvent-soluble organic nanoparticles. Various polyester, polycarbonate, polyanhydride, or polyamide polymers or copolymers can be successfully removed by a degradation mechanism. (Those skilled in the art of polymer synthesis understand that there can be considerable overlap between the “dissolution” and “degradation” mechanisms, e.g., some of the degradable polymers can have the solubility characteristics amenable to removal by way of dissolution. Moreover, degradation products of the degraded polymers may be more amenable to subsequent dissolution in select solvents).

As a more specific illustration, the polymer material may be partially or substantially removed by treatment with alcohols or with aromatic solvents (some of which may also technically be alcohols). Non-limiting examples of the alcohols include ethanol, isopropanol, and butanol; as well as polyalcohols, such as ethylene glycol, propylene glycol, and glycerol. Non-limiting examples of the aromatic solvents include toluene, xylene, benzene, phenol; and various combinations thereof. Other solvents may be very useful as well, e.g., cresol, chlorobenzene; dimethyl acetamide; dimethyl formamide, ketone solvents such as dimethyl ketone and methyl isobutyl ketone; and the like. Relatively weak acids could also be used, e.g., acetic acid, citric acid, oxalic acid, maleic acid, and combinations thereof.

In most cases, a solution used for the dissolution process can be employed as a bath, in which the matrix/substrate is immersed. Various alternatives are also possible. For example, the dissolution composition could be sprayed or brushed over the matrix/substrate, for a period of time sufficient to remove the desired amount of the particle material.

Other removal techniques may also be possible. As one example, the particle material may be partially or substantially removed by thermal techniques, e.g., melting or “burning out” the particle material in a convection oven. In that instance, care should be taken to maintain the temperature at a level that does not adversely affect the matrix. As still another alternative, radiation or electron beam (EB) techniques could be used to remove the particle material.

As further depicted in FIG. 1E, the resulting membrane material includes a pattern of pores 42, which may be closely packed. In many embodiments, the membrane can be considered as having two types of pores. Pores 42 result directly from removal of material from particles 12, and may be thought of as the “primary pores”. They are bounded and defined by an outer rim or border 44 for each pore, and are surrounded and contained by the cured matrix 38. In some (though not all) specific embodiments, the primary pores have an average diameter in the range of about 50 nm to about 1000 nm, and more specifically, about 75 nm to about 250 nm.

Pores 43 can be considered as “secondary pores”, and are also contained within the cured matrix. These pores are defined by the contact points which initially existed between particles 12. The secondary pores can, at this stage, be thought of as “interparticular voids”. It should be noted, however, that majority of the primary pores 42 are substantially interconnected by the secondary pores 43. As used herein, a “pattern of pores” is meant to include both pores 42 and pores 43. In some embodiments, the secondary pores usually have an average diameter in the range of about 10 nm to about 100 nm.

With continued reference to FIG. 1E, primary pores 42 are shown as being completely empty in this figure. However, it should be clear from this disclosure that the pores can still remain partially filled with particle material. In that instance, enough open space should remain for the pores to effectively provide the desired filtration function. Moreover, the residual particle material (e.g., a latex polymer) should not be one that would adversely affect (e.g., contaminate) the desired filtration product. In some preferred embodiments, the spheres and resulting pores are closely-packed, or substantially closely-packed. (As used herein, “close-packed” refers to the maximum number of spheres that can be arranged in or “packed” into a selected area).

In another embodiment of the invention, the substantially spherical particles (which will eventually function as pores, as in the previous embodiment) can be disposed on a porous substrate. The porous substrate is capable of containing a first chemically-reactive material. When the chemically-reactive material is contacted with a second reactive material capable of reacting with the first reactive material, a polymeric-type material is formed in the general, reaction region, i.e., an interface. The polymeric-type material functions as a matrix that surrounds and contains the spherical particles.

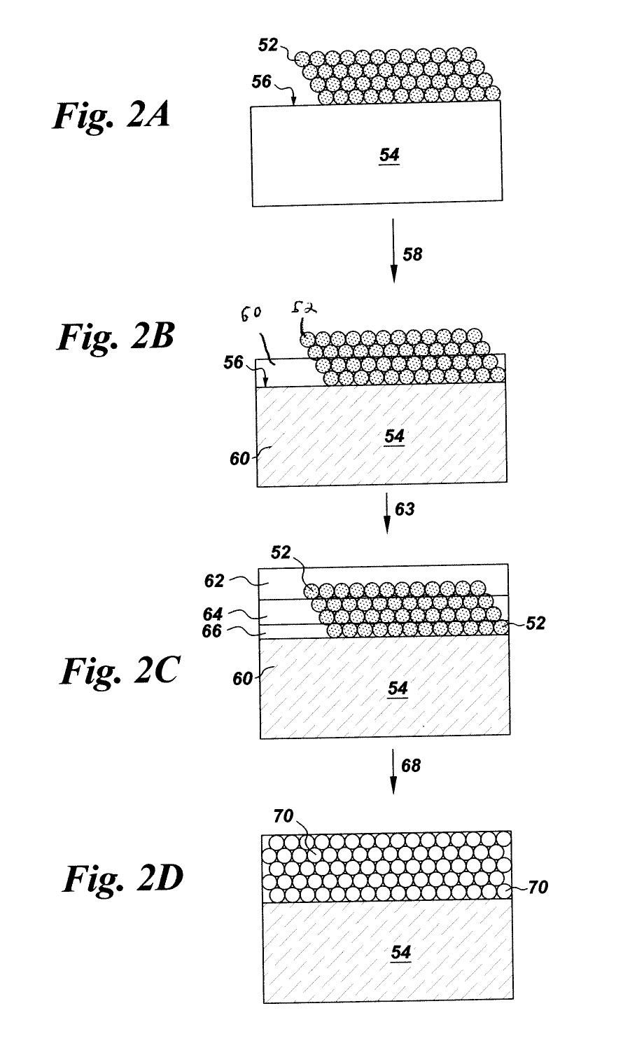

One non-limiting depiction of this embodiment is set out in FIG. 2. Spherical (or substantially spherical) particles 52 are disposed on substrate 54, as depicted in FIG. 2A. Particles 52 can have a composition as described in the previous embodiments. The substrate 54 can be formed from a variety of different materials or combinations of materials. The substrate can also be in a variety of shapes and sizes, as long as spherical particles 52 can be suitably disposed on at least one selected surface 56 of the substrate. As alluded to above, the substrate should preferably have a porosity or “permeability” sufficient to allow effective formation of a particle template from a particle dispersion.

In some specific embodiments, the substrate can be in the form of an ultrafiltration membrane. Ultrafiltration membranes (“UF” membranes) are commercially available from many sources. They include, for example, Millipore Corporation, Koch Membrane Systems, General Electric, and Pall Corporation. UF membranes can be found in a variety of configurations, e.g., flat sheet, tubular, hollow fiber, spiral, and pleat type. Moreover, they may be made from a variety of inorganic or organic materials (e.g., polymers). Non-limiting examples of the organic materials include cellulose acetate, polyacrylonitrile, polysulfone, polyether sulfone, polyamides, polyvinyl alcohols, polyvinyl halides, polystyrenes, and various blends or copolymers that contain any of the foregoing. With reference to FIG. 2A, particles 52 can be poured, cast, sprayed, or deposited over surface 56 of the substrate by any suitable technique.

Various compositions can be used for the first chemically-reactive material for this embodiment. Choice of a particular material will depend on various factors. They include: the type of material from which the membrane/substrate is formed; the identity of a second reactive material which will react with the first material; and the compatibility of the reactive material with the materials which form particles 52.

In some instances, the first reactive material is an amine-containing compound or other amine-containing composition, e.g., one that includes primary and/or secondary amines. The amine component can also be in the form of a polymer, which includes amine functionalities, e.g., an amine-terminated polymer resin. Amine-based materials are described in U.S. Pat. No. 6,753,363 (Harashina), which is incorporated herein by reference. Non-limiting examples include polyethylene imine, polyvinylamines, polyaminomethyl-styrene, polyaminoethylstyrene, polyetheramines; and amino resins formed by various reactions with formaldehyde. In some specific embodiments, the amine-based material is a polyallylamine, e.g., one having the backbone [—CH₂CH(CH₂NH₂)—]. Such materials are commercially available (e.g., from the Aldrich catalogue), as are related materials, such as hydrochloride derivatives.

For embodiments in which the templated membranes are used for virus filtration, polyallylamines and derivatives thereof are sometimes preferred as one of the reactive materials, e.g., the “first reactive material”. For example, the polyallylamines can be incorporated into “Q resins”, i.e., quaternary amines. (See, for example, a description of such resins at http://www.proteinchemist.com/tutorial/iec.html. Relevant information is also provided in “Biotechnology Progress”, 22, 341-349 (2006); and in “Membrane Handbook”, W. S. Ho, K. K. Sirkar (eds.) © 1992, Van Nostrand Reinhold, New York), all of which are incorporated herein by reference. Membranes prepared from such materials can exhibit a positive electrical charge. It is thought that such a characteristic can enable the membrane to be more effective in retaining and binding negatively-charged biomolecules, such as some of the virus particles; as well as DNA.

Other amine-containing materials which are preferred for some embodiments include various amine-containing copolymers, such as poly(vinylalcohol-co-vinylamine). Amine-containing polyacrylates, -methacrylates, -acrylamides, or -methacrylamides, such as poly(2-aminoethylmethacrylate), are also favored in some embodiments. In other instances, amine-containing aromatic polymers and copolymers, such as poly(4-amino styrene), are preferred.

With reference to step 58 and FIG. 2B, the first reactive material 60 can be incorporated into substrate 54 by various techniques. Examples include injecting from a suitable dispenser, or spraying the material on and into the substrate. (The amine materials are usually water-soluble, and can be dispersed in an aqueous solution. This is a considerable processing advantage for many embodiments). In some instances, the substrate 54 can be immersed in a solution of the amine-based material. For all of these techniques, care should usually be taken to prevent the first reactive material from being applied to a location on or near the substrate which might invite premature reaction with a second reactive material, as further discussed below. It should also be mentioned that substrate 54 could alternatively be “loaded” with the first reactive material, prior to the placement of spherical particles 52 on substrate surface 56. (First reactive material 60 is also shown disposed over surface 56).

As mentioned previously, the second reactive material is one that will react with the first reactive material, so as to form a matrix that will contain the spherical particles. Thus, choice of the second reactive material will depend in large part on the identity of the first material. As one example, when the first reactive material is an amine-based material, the second reactive material can be an isocyanate material, i.e., one having “—NCO” functional groups. Non-limiting examples of such materials include toluene diisocyanate (TDI); methylene diphenyl diisocyanate (MDI); and isophorone diisocyanate (IPDI). Many commercial products of these types exist, e.g., the Desmodure® and Burnock® product lines.

As depicted in FIG. 2C, reaction of the second reactive material with the first reactive material, i.e., the amine-based material, results in a polyurea material that can effectively serve as the matrix. Those skilled in the chemical and polymer arts understand that derivatives of polyurea materials can be formed by using various derivatives of one or both of the starting materials. Moreover, the reaction of the first and second materials can be carried out in the presence of a suitable catalyst in some instances, e.g., organometallic compounds and the like.

As mentioned above, other materials and “pairs” of materials could constitute the first and second reactive materials. As a non-limiting example, when the second reactive material is an isocyanate, the first reactive material can be at least one compound or polymer containing at least one hydroxy (e.g., alcohol) or phenolic-type group. The end-product in this instance would be a polyurethane polymer, serving as the matrix.

As those skilled in the art understand, alcohols fall into primary, secondary, or tertiary subsets. Typically (though not always), the alcohol component is a polyol, e.g., polyether polyols such as polyethylene glycol, polypropylene glycol, or polytetramethylene glycol. Choice of particular starting materials like the alcohols will depend in part on the desired properties for the final membrane, e.g. flexibility, strength, and the like. The alcohol component could be incorporated into the porous substrate in a manner similar to that employed for the polyallylamine materials. Moreover, catalysts (e.g., amine catalysts) are sometimes used in the preparation of polyurethanes, and are typically pre-combined with the alcohol component.

Those skilled in the art (e.g., organic synthesis) are familiar with various details regarding these types of “interfacial reactions”. Exemplary references include “Interfacial Synthesis”, Volume 2, Polymer Applications and Technology; 529 pages. Marcel Dekker, Inc. New York, © 1977, Frank Millich and Charles Carraher Jr. (ed), which is incorporated herein by reference; and in the Kniajanski publication mentioned previously.

Still another example of a pair of first and second reactive materials can be provided. The first reactive material could be an epoxy or polyepoxide material, e.g., one based on epichlorohydrin and a polyol, such as bisphenol-A. The second reactive material could then be an amine or an anhydride curing agent for the epoxy material. As known in the art, derivatives, blends, or copolymers of the epoxy polymers can alternatively be used, e.g., epoxy-polysiloxane compositions.

As yet another example, the first reactive material could be an ethylenically unsaturated composition, e.g., an acrylic or vinyl material. In that instance, the second reactive material could be a catalyst composition, e.g., a peroxide curing agent with a metal activator. Other activator systems could be used, e.g., those formed from alcohol/acid catalyst mixtures; or those based on ferrocene and various diazonium salts. Some of the 2-pack acrylic compositions are described in U.S. Pat. No. 4,638,035 (McGinniss), which is incorporated herein by reference. Derivatives, blends, or copolymers of such compositions are also possible, e.g., 2-pack acrylic-modified polysiloxane compositions.

As shown in FIG. 2B, the first reactive material 60 is incorporated into (and over) substrate 54. The second reactive material 62 is put into a position to contact first material 60. Various techniques for depositing second material 62 are possible. For example, the material could be poured, cast, or sprayed over particles 52. (Furthermore, it should also be noted that, in some instances, and with consideration of the various factors described previously, the use of “first” and “second” materials can be interchanged, i.e., the second material being incorporated into the substrate, and the first material contacting the particles from another direction, e.g., from above the substrate).

In step 63, first reactive material 60 and second reactive material 62 react at an interface 64 between the materials. As shown in FIG. 2C, the interface, or “interfacial region”, generally contacts and surrounds spherical particles 52. (Layer 66 represents the portion of the first reactive material which did not contact and react with the second reactive material). The reaction between the two reactive materials is temperature-dependent, but can take place rapidly at ambient temperatures. For example, the polyurea- or polyurethane-forming reactions, at 25° C., may take place in seconds, and generally, less than about 1 minute. The resulting polymeric material functions as the matrix for particles 52. The portion of the second reactive material 62 which has not reacted with the first reactive material can be decanted or otherwise removed from the membrane.

With reference to FIG. 2D, at least a portion of the spherical particle material 52 can then be removed in step 68. The techniques described above can be employed, e.g., acid or base solutions for inorganic particles; solvent etching for polymeric particles, thermal techniques, and the like. (Use of these processes can also remove unreacted layer 62). The resulting structure includes an ordered or partially-ordered pattern of hollow or partially hollow spheres 70, attached to substrate 54. Such a structure can effectively function as a filtration membrane, as discussed previously. (The actual membrane structure may differ slightly in size and/or shape, because layer 66 may not be transformed into a portion of the ordered pattern of spheres, as mentioned above).

In another embodiment of this invention, the substantially spherical particles, which will eventually form the template for the porous structure, are provided with reactive functional groups. The functional groups are usually disposed on an exterior surface of the particles, and will react with another reactive material, to form the cured matrix, which will contain the particles. The functional groups can be physically adsorbed or chemically attached to spherical particles that have already been formed; or may be incorporated into the particles during their formation.

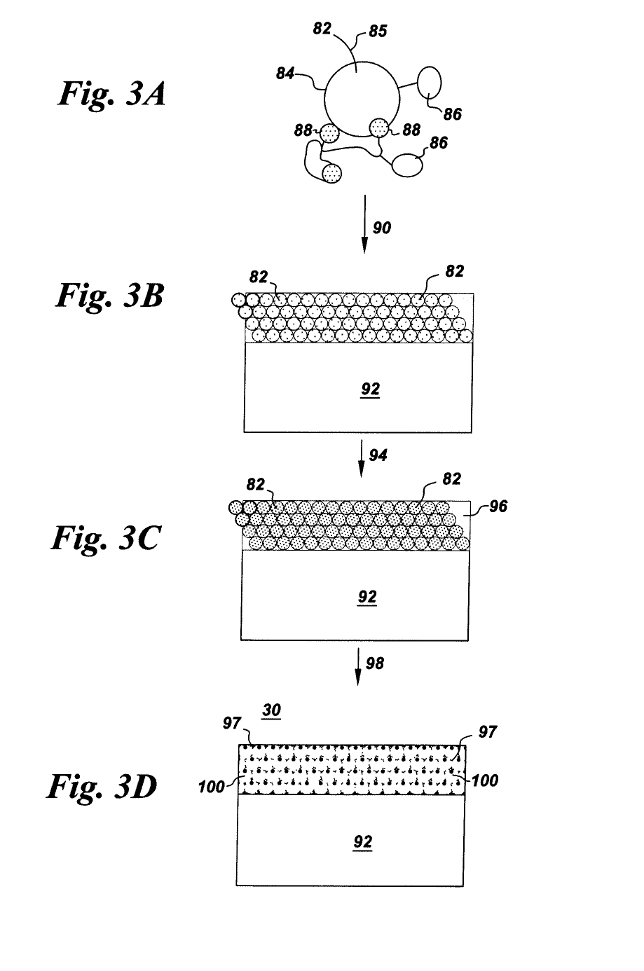

A spherical particle 82 (one of a multitude which will eventually form the porous structure) is depicted in FIG. 3A, in an enlarged view. The particle, usually an organic material in this embodiment (e.g., a polymer), has an outer surface 84. Functional groups 86, labeled as “Rx”, are shown as being attached to surface 84.

The reactive groups may be functional moieties contained in a wide variety of monomers or oligomers (e.g., compositions), which constituted the reactive materials discussed for previous embodiments. As one non-limiting example, functional groups 86 may comprise amines (—NH₂) such as hydroxylamine, amine derivatives, or other amine-containing compositions. The amine component can also be in the form of a polymer that includes amine functionalities, e.g., an amine-terminated polymer resin.

The functional group-containing material (sometimes referred to herein as the “functionalizing material”) can be poured over spherical particles 82, mixed with the particles, or combined with the particles by any other suitable technique. In this manner, functional groups 86 (as well as functional groups 85, when present) become attached to, adsorbed on, or localized around surface 84. (It should be understood that, in this embodiment, the functional groups may be physically attached to surface 84, although there may be some “chemical attachment” as well, i.e., chemical bonding to the material which forms the particles. Regardless, the functional groups are considered to be “chemically reactive” because of their reactivity with a second chemically reactive material, as described below). The amount of functional group-containing material used to contact particles 82 will depend on various factors, e.g., the type of functional material and spherical particle. Those skilled in the art can determine the most appropriate amount, based in part on the quality and size of the matrix subsequently formed, as also discussed below.

In some embodiments (though not all), hydrophobic surfactants may be employed to increase the attraction (e.g., adsorption) between outer surface 84 and the functionalizing material. As simplistically depicted in FIG. 3A, the hydrophobic materials 88 can provide attachment sites on the surface. A variety of materials (e.g., hydrophobic group-containing materials) can be used for this purpose. Non-limiting examples include a number of hydrophobic modifiers or surfactants. (Many are considered “nonionic surfactants”). These materials are usually based on compounds that contain substantially nonpolar organic moieties. Some examples of the hydrophobic modifiers include ethoxylated nonylphenol surfactants; and polymer materials such as functionalized polyoxypropylene-polyoxyethylene block copolymers. Such materials are commercially available, e.g., under the Pluronic® or Dobanol® trade names. The hydrophobic material may be incorporated into the functionalizing material, or into another treatment solution to which the particles 82 are exposed. Those skilled in the art will be able to readily determine the most appropriate level of hydrophobic agent for a given situation.

As another alternative mentioned above, the functionalizing material can be incorporated into spherical particle 82 during the preparation of the particle. As an example, a functionalizing material, such as one of the amine compounds described previously, can be incorporated into a colloidal dispersion used to form a spherical latex particle. When the particle 82 is polymerized and formed, some of the functionality (i.e., reactive groups 86) from the amine compound would be located in the surface region of the particle, e.g., “protruding” from the surface.

As shown by step 90 of FIG. 3B, spherical particles 82—now having a functionalized outer surface—can be disposed on substrate 92. The substrate can be formed from many different materials, as described in previous embodiments, and can be in many different shapes. Very often, the substrate would be formed from a porous, UF material, although porosity is not required for this embodiment.

In step 94, a second reactive material 96 is placed into contact with the functionalized particles 82 (FIG. 3C). As in the other embodiments, the second material is one that will chemically react with the first material (i.e., with the functionalizing agent on the particles), so as to polymerize or cure, forming the desired matrix. The second material can be deposited over the particles by the various techniques described previously. Reaction between the second reactive material and the functionalized particles will form the matrix 97 of the desired polymer, e.g., a polyurea, polyurethane, epoxy, and the like.

In step 98, at least a portion of the material of spherical particles 82 is removed. Suitable removal techniques were described previously, e.g., with solvents or thermal techniques. The resulting structure depicted in FIG. 3D includes an ordered pattern of hollow or partially hollow spheres 100, held firmly in place within matrix 97, and attached to substrate 92. As in the other embodiments, such a structure can effectively function as a filtration membrane. Another embodiment of this invention is directed to such a membrane. One specific type of interest includes a polymeric matrix which contains polyallylamine functionality.

### EXAMPLES

The examples which follow are merely illustrative, and should not be construed to be any sort of limitation on the scope of the claimed invention.

The template prepared in this example was formed on the top surface of a section of a polyethersulfone membrane (300,000 MWCO material; from GE Healthcare, Westborough, Mass.). The membrane was in the shape of a flat sheet, and had approximate dimensions of 8 inches×8 inches (20 cm×20 cm). The spherical particles were provided in the form of a polystyrene (PS) latex dispersion (Polysciences, Inc., Warrington, Pa.). The average particle size (diameter) in the dispersion was about 96 nm.

The polystyrene-based template was formed by draw-down casting of the polystyrene dispersion on the top surface of the membrane substrate. The template was then allowed to dry, and had an approximate thickness of 500 nm to 2 microns. A 2.5% polyallylamine (PAA) solution in water was loaded from the backside of the membrane substrate. While the membrane was still wet, a 2% solution of toluene diisocyanate (TDI), in isopropanol (IPA), was applied to the template surface, to carry out the interfacial reaction described above. 30 seconds later, the sample was impregnated in IPA for 15 seconds, followed by drying in air. The resulting material was then examined with a scanning electron microscope (SEM).

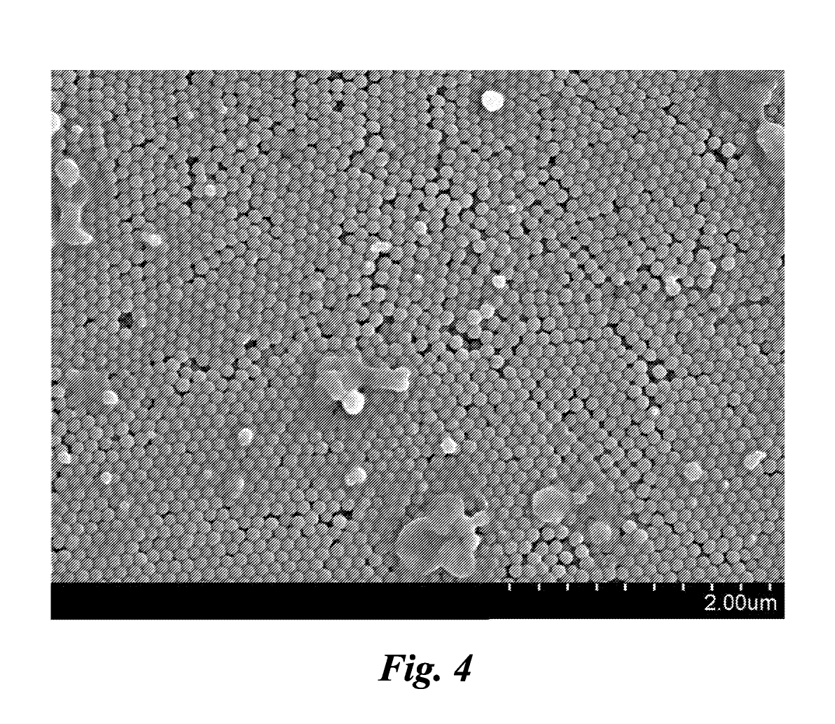

FIG. 4 is an SEM image that shows the surface morphology of the resulting polystyrene particle template, after the interfacial reaction is complete. The polystyrene spheres are closely packed together. The polyurea-based matrix is visible to some extent, beneath and between the polystyrene particles.

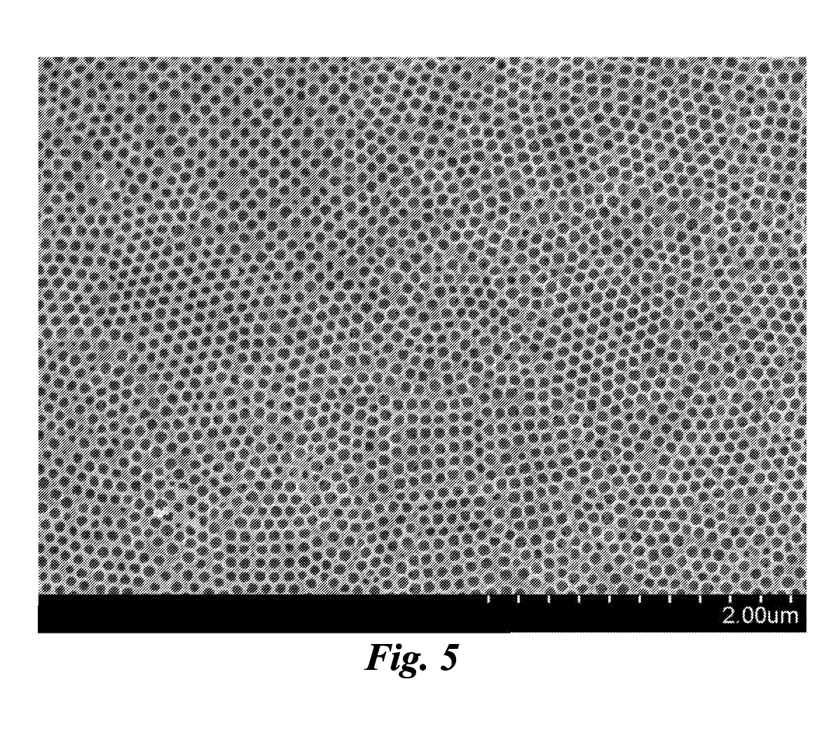

FIG. 5 is an SEM image of a polystyrene particle-templated membrane, prepared by a technique substantially identical to that used for the sample upon which FIG. 4 was based. In this instance, after reaction between the TDI/PAA, the templated membrane was etched in solvent, by exposure to a solution of toluene for approximately 5 minutes. The resulting membrane was then dried in air, for examination under SEM. The figure shows a pattern of primary pores, contained within a matrix. These pores resulted from the removal of the original particle material by etching, as discussed previously. The pores are generally spaced from the other primary pores, although in some of the other samples, some of the primary pores were linked or “necked” to other pores.

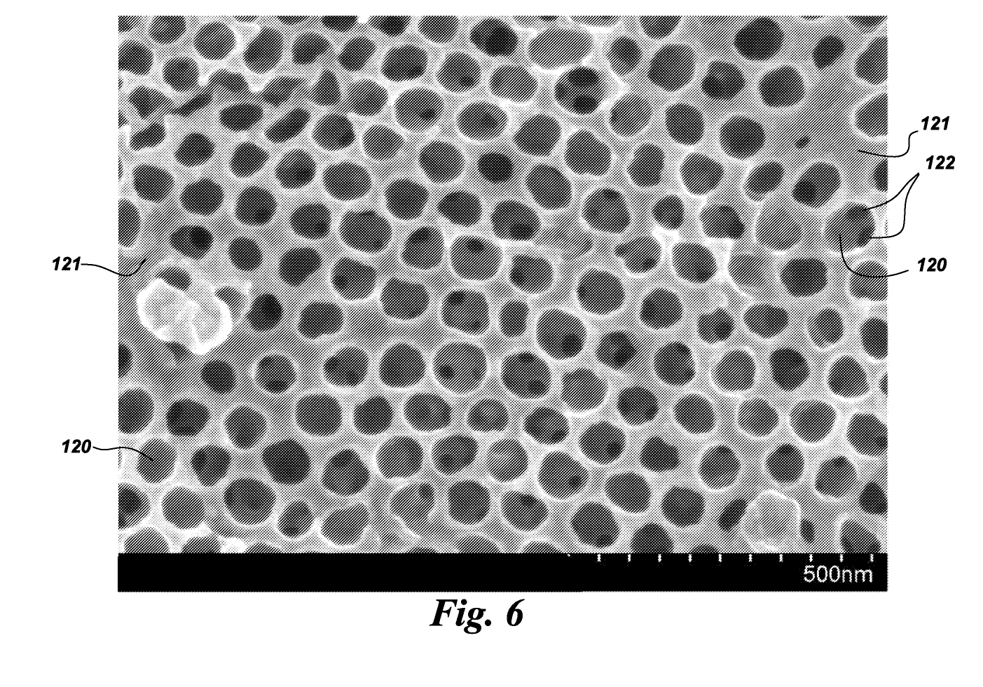

FIG. 6 is an SEM image of another particle-templated membrane sample. The sample was prepared in a manner similar to that used for the membrane of FIG. 5. In this instance, a 2.5% polyallylamine (PAA) solution in water was loaded from the backside of the membrane substrate, followed by drying in air. The specimen was then flushed with deionized water, and dried again in air. Subsequently, the sample was saturated with water from the backside of the membrane substrate. While the membrane was still wet, a 1% solution of TDI in a mixture of 70% Butanol/30% IPA was applied to the template surface, to carry out the interfacial reaction described above. 30 seconds later, the sample was impregnated in IPA for 15 seconds, followed by a drying step in air. The templated membrane precursor was etched in solvent, by placing it in a solution of toluene for approximately 3 minutes. A last drying step, in air, was carried out, prior to the SEM study.

As in the case of FIG. 5, FIG. 6 shows a pattern of primary pores 120. The pores are contained within a matrix 121. The relatively small, secondary pores 122 are also clearly present.

While the invention has been described with reference to exemplary embodiments, it will be understood by those skilled in the art that various changes may be made and equivalents may be substituted for elements thereof, without departing from the scope of the invention. In addition, many modifications may be made to adapt a particular situation or material to the teachings of the invention, without departing from the essential scope thereof. Therefore, it is intended that the invention not be limited to the particular embodiment disclosed as the best mode contemplated for carrying out this invention. Moreover, all patents and other references mentioned above are incorporated herein by reference.

1. A method for the formation of a membrane, comprising the steps of:
a) contacting a collection of substantially spherical particles with at least one reactive material, wherein the particles are formed from a selected particle material;
b) reacting the reactive material, so that it forms a matrix that substantially surrounds and contains the particles; and
c) removing at least a portion of the particle material from the particles, so that the matrix comprises a pattern of pores which are permeable to selected substances in solution.

2. The method of claim 1, wherein the particles comprise an inorganic material, or a combination of an inorganic material with an organic material.

3. The method of claim 2, wherein the inorganic material is selected from the group consisting of silica, titania, zirconia, alumina, ruthenium oxide, tin oxide, titanium, zirconium, aluminum, chromium, iron, zinc, nickel, gold, silver, platinum; calcium, calcium precipitates; cermets; and combinations thereof.

4. The method of claim 1, wherein the particles comprise an organic material.

5. The method of claim 4, wherein the organic material comprises an organic polymer.

6. The method of claim 5, wherein the organic polymer is selected from the group consisting of polystyrene, polyamide, polyethylene, polypropylene, polycarbonate, polyester, polyacrylates, polymethacrylates, polyacetals, polybutenes, polyacryamides, polyalkylene glycols, polysiloxanes, polyphenylene sulfides, polylactides, polysaccharides; mixtures of any of the foregoing; and copolymers of any of the foregoing.

7. The method of claim 4, wherein the particles comprise latex particles.

8. The method of claim 7, wherein the particles comprise polystyrene latex spheres.

9. The method of claim 1, wherein the reactive material is a monomer or oligomer which is curable by the action of heat, radiation, a catalyst, or a combination of any of the foregoing.

10. The method of claim 1, wherein the reactive material comprises at least one monomer or oligomer selected from the group consisting of acrylates, methacrylates, isocyanates, isothiocyanate, carbonyl chlorides, epoxides, sulfonyl chlorides, amine, alcohol, phenol, anhydride, thiol, and combinations of any of the foregoing.

11. The method of claim 10, wherein the spherical particles comprise a latex polymeric material dispersed in the reactive material, so as to form an emulsified mixture, and the reactive material is substantially hydrophobic, and is in substantial contact with an outer surface region of the particles.

12. The method of claim 11, wherein the emulsified mixture is applied as a layer to a substrate, prior to step (b), and voids between the particles are substantially filled with the reactive material.

13. The method of claim 12, wherein the reaction of the reactive material is a curing process, to form a cross-linked matrix in which the spherical particles are contained.

14. The method of claim 1, wherein at least a portion of the selected particle material is removed in step (c) by a technique selected from the group consisting of solvent dissolution, degradation, etching, thermal treatment, radiation, and combinations thereof.

15. The method of claim 1, wherein the spherical particles have an average diameter in the range of about 50 nm to about 1000 nm.

16. The method of claim 1, wherein the substantially spherical particles are in contact with a first reactive material that is disposed on the surface of a porous substrate.

17. The method of claim 16, wherein a second reactive material is placed into contact with at least a portion of the first reactive material and with the spherical particles, so that the two reactive materials react at an interface, to form a cured matrix material in which the particles are contained.

18. The method of claim 17, wherein the first reactive material is incorporated into the porous substrate, prior to contact with the second reactive material.

19. The method of claim 17, wherein the second reactive material comprises isocyanate groups; the first reactive material comprises hydroxy groups; and the cured matrix material comprises a polyurethane polymer.

20. The method of claim 17, wherein the second reactive material comprises isocyanate groups; the first reactive material comprises amine groups; and the cured matrix material comprises a polyurea polymer.

21. The method of claim 17, wherein the reaction of the two reactive materials at the interface is carried out in the presence of at least one catalyst.

22. The method of claim 17, wherein the reaction of the first and second reactive materials at the interface is carried out in the presence of at least one amine compound and at least one organometallic compound.

23. The method of claim 17, wherein at least a portion of the selected particle material is removed in step (c), after the formation of the cured matrix material.

24. The method of claim 1, wherein the outer surfaces of the spherical particles are treated with a first reactive material, prior to step (b), so that functional sites capable of reacting with a second reactive material are present on or near an outer surface of the particles.

25. The method of claim 1, wherein a first reactive material is incorporated into the spherical particles during their formation, so that functional sites, derived from the first reactive material and capable of reacting with a second reactive material, are present on or near an outer surface of the spherical particles.

26. The method of claim 1, wherein the matrix, after step (c) of claim 1, comprises primary pores formed by the removal of the particle material; and secondary, smaller pores which are generally present at contact sites between the primary pores.

27. An interfacial method for the formation of a membrane, comprising the steps of:
a) contacting a collection of substantially spherical particles, which are formed of a selected particle material, and which are disposed on a substrate which contains a first reactive material, with a second reactive material, at an interface between the two reactive materials, so that a matrix is formed by reaction between the two reactive materials, said matrix substantially surrounding and containing the particles; and
b) removing at least a portion of the selected particle material from the particles, so that the matrix comprises a pattern of pores which are permeable to selected substances in solution.

28. The interfacial method of claim 27, wherein the particles comprise an organic polymer;
the substrate comprises an ultrafiltration (UF) membrane; and
the first and second reactive materials each comprise chemical constituents which, when reacted with the other reactive material; form a cured matrix which comprises a polyurea polymer; a polyurethane polymer; an epoxy polymer; or an acrylic polymer.

29. The interfacial method of claim 28, wherein the particles comprise a polystyrene latex polymer.

30. A filtration membrane, comprising a polymeric matrix which contains polyallylamine functionality or polyallylamine-derivative functionality, wherein the matrix further comprises a distribution of primary pores and secondary pores, wherein the secondary pores are smaller in size than the primary pores; and are present at contact sites between the primary pores.
